(19) United States
(12) Patent Application Publication
(10) Pub. No.: US 2008/0154738 A1
(43) Pub. Date: Jun. 26, 2008

(54) INTERACTIVE MARKETPLACE INFRASTRUCTURE

(75) Inventors: Kamal Jain, Bellevue, WA (US); Raymond E. Ozzie, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/615,442

(22) Filed: Dec. 22, 2006

(51) Int. Cl. G06Q 30/00

(52) U.S. Cl. 705/26

(57) ABSTRACT

Online marketplace experiences are substantially enhanced by employing marketplace infrastructures. A marketplace infrastructure can provide structured features desired by most customers without requiring a user to be redirected from the marketplace. Marketplace infrastructure mechanisms allow these features to be called based on intentions shown by users. In one instance, this is accomplished by utilizing icons placed in proximity of the marketplace. Users show their interest in the icons to initiate the desired feature. Once initiated, a user can then interact with the feature provided by the marketplace infrastructure. This substantially increases the speed at which purchasing steps can be made.

### BACKGROUND

Merchants today typically utilize some form of online advertising to augment at least part of their business transactions. This can range from advertising on websites to hosting their own websites, complete with shopping mechanisms and transaction processing systems. Although having a web site totally dedicated to a single merchant is great for providing in-depth product information and services, customers must still find the website before they can decide to make a purchase. To draw customers to their sites, merchants often advertise online in locations they feel will bring the most interested customers to their sites. Key advertisement locations tend to be where web-surfers “hang out” or loiter for long periods of time each day. For example, most web users utilize some form of search engine while online. Thus, advertising on search engine pages has become quite popular with merchants.

The search engine web page becomes a marketplace of sorts with advertisements typically geared to search queries. Links to merchants are provided on the search page so that users can click on links they are interested in. To entice users even more, directed advertising links are provided that might tout bargain priced items and the like. A user still must click on the link and wait for the merchant's page to load to see if they are truly interested in the merchant's item. Because of this delay, some potential customers may skip clicking on the link because they don't have time to load every merchant page they are interested in. This is especially true if a customer desires to do comparison shopping in such a marketplace. They would have to click on each link and write down prices or go to a dedicated comparison shopping site, taking them away from their task at hand—using the search engine.

### SUMMARY

Mechanisms for providing marketplace infrastructure are utilized to enhance a user's online marketplace experience. The user is now empowered to instantly view marketplace features such as, for example, pricing information, direct and/or indirect communications with merchants to obtain additional product information, and/or easy purchasing options and the like. The marketplace infrastructure mechanisms allow these features to be initiated based on intentions shown by users while in the marketplace. In one instance, this is accomplished by utilizing icons placed in proximity of the marketplace. Users can use various means to show their interest in the icons to initiate the desired feature. Once initiated, a user can then interact with the feature provided by the marketplace infrastructure. This substantially increases the speed at which purchasing steps can be made. For example, a user can easily call up pricing comparisons, request a talk with the merchant for more product information and availability, and drag and drop a payment for the item desired without leaving the marketplace.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a marketplace infrastructure system in accordance with an aspect of an embodiment.

FIG. 2 is another block diagram of a marketplace infrastructure system in accordance with an aspect of an embodiment.

FIG. 3 is yet another block diagram of a marketplace infrastructure system in accordance with an aspect of an embodiment.

FIG. 4 is an illustration of an online marketplace in accordance with an aspect of an embodiment.

FIG. 5 is an illustration of an example merchant search query infrastructure in accordance with an aspect of an embodiment.

FIG. 6 is an illustration of an example voice over IP merchant communication infrastructure in accordance with an aspect of an embodiment.

FIG. 7 is an illustration of an example Instant Messaging (IM) merchant communication infrastructure in accordance with an aspect of an embodiment.

FIG. 8 is an illustration of an example Instant Messaging (IM) merchant Bot communication infrastructure in accordance with an aspect of an embodiment.

FIG. 9 is an illustration of an example email merchant communication infrastructure in accordance with an aspect of an embodiment.

FIG. 10 is an illustration of an example advertisement forwarding infrastructure in accordance with an aspect of an embodiment.

FIG. 11 is an illustration of an example advertisement clipping infrastructure in accordance with an aspect of an embodiment.

FIG. 12 is an illustration of an example calendar entry infrastructure in accordance with an aspect of an embodiment.

FIG. 13 is an illustration of an example batch purchasing infrastructure in accordance with an aspect of an embodiment.

FIG. 14 is an illustration of an example drag and drop purchasing infrastructure in accordance with an aspect of an embodiment.

FIG. 15 is an illustration of an example auction and/or negotiation infrastructure in accordance with an aspect of an embodiment.

FIG. 16 is an illustration of an example feedback infrastructure in accordance with an aspect of an embodiment.

FIG. 17 is a flow diagram of a method for providing online marketplace infrastructure in accordance with an aspect of an embodiment.

FIG. 18 is a flow diagram of a method for selecting online marketplace infrastructure in accordance with an aspect of an embodiment.

FIG. 19 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Mechanisms are utilized to enhance a marketplace by providing additional infrastructure for purchasing products and/or services and the like. These marketplace infrastructures can create new structures and/or utilize external structures from sources such as a merchant's web site and/or a client computing system and the like. One instance utilizes standardized icons in advertisements which provide the additional infrastructures. When a user shows intent, the infrastructure initiates a desired feature supported by the infrastructure. These features can include, for example, a quick drag-and-drop buying experience, batch purchase across several merchants, integration of Instant Messaging (IM) and/or voice-over-IP (VOIP) to communicate directly with a merchant and/or its Bot and/or integration of negotiation platforms such as auctions and the like.

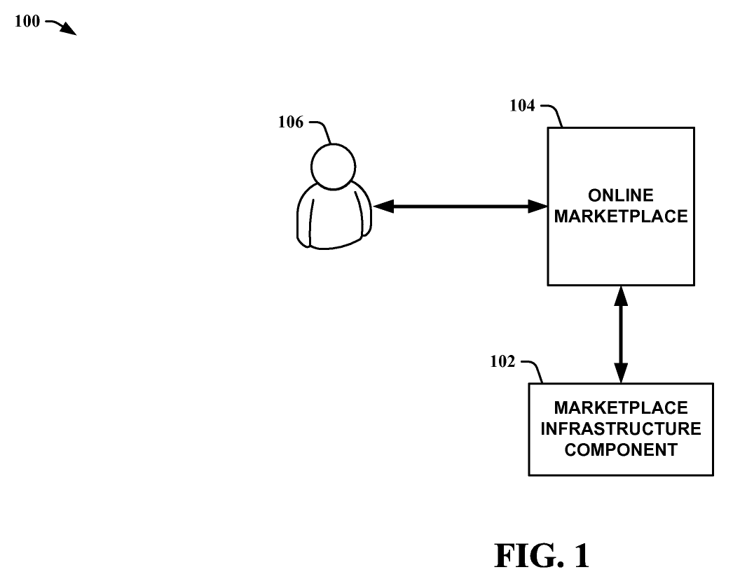

FIG. 1 illustrates a marketplace infrastructure system 100 that utilizes a marketplace infrastructure component 102 to provide purchase-associated infrastructure to an online marketplace 104. A user 106 interfaces with the online marketplace 104 and can initiate various purchase-associated features supported by the infrastructure. In one instance, the user 106 can initiate a feature by showing intention in the online marketplace 104. Intention by the user 106 can be determined, for example, by how the user 106 interacts with an advertisement and the like. An advertisement in the online marketplace can have, for example, an icon associated with it that can initiate a feature supported by the infrastructure from the marketplace infrastructure component 102. Thus, the user 106 can show intent by clicking the icon, hovering over the icon with a pointing indicator, pausing for a time on the advertisement, looking at the advertisement (eye movement sensors employed), and/or other mechanisms that determine the user's intent (e.g., environmental sensors, thought sensors, etc.).

The marketplace infrastructure component 102 provides infrastructure to the online marketplace 104 that enhances the user's purchasing experience without redirecting the user to other web sites. Purchase-associated information can now be presented to the user 106 without requiring additional clicks and/or following additional hyperlinks, etc. The information and/or interactions can be performed right in the online marketplace 104. This is particularly beneficial when the user 106 does not have the extra time required to navigate to other web pages. Merchant sales can be substantially increased because of the speed at which the user 106 can obtain product/service information and/or complete purchases and the like. For example, the user 106 can employing a search engine on a web site that includes the online marketplace 104. The user 106 may be doing research for a school paper and is under a tight deadline. The user 106 suddenly realizes they are hungry and shows intention towards a pizza advertisement with infrastructure supported by the marketplace infrastructure component 102. A pop-up window, for example, can show pizza menu items with selectable prices. The user 106 can select a desired option within the window and then drag their credit card information to the window for instant payment (essentially “less than one click” payment) and delivery address. The user 106 continues to do research on the web site while their pizza is being delivered, the purchase process resulting only in a minor interruption of the user's task at hand. In this example, a merchant obtained a sale that would likely not have been made otherwise (the user 106 might have reasoned that making a sandwich would be quicker than looking up a pizza parlor and calling to order, etc.).

The online marketplace 104 can be a dedicated web site and/or a portion of a web site as in the above search engine example. The user 106 can access the online marketplace 104, for example, via a client computing device that interfaces with a server that hosts the online marketplace 104 and/or via a mobile computing device that interacts with the host server. The online marketplace 104 can be, for example, a text-based and/or a graphics-based marketplace. Thus, the user 106 can interact with, for example, a picture of a pizza and/or the word “pizza” and the like in reference to the above pizza purchase. In some instances, the online marketplace 104 can accept verbal commands and/or other types of commands as well. In these scenarios, for example, the user 106 can speak the word “pizza” and/or think “pizza” and show intention in the online marketplace 104.

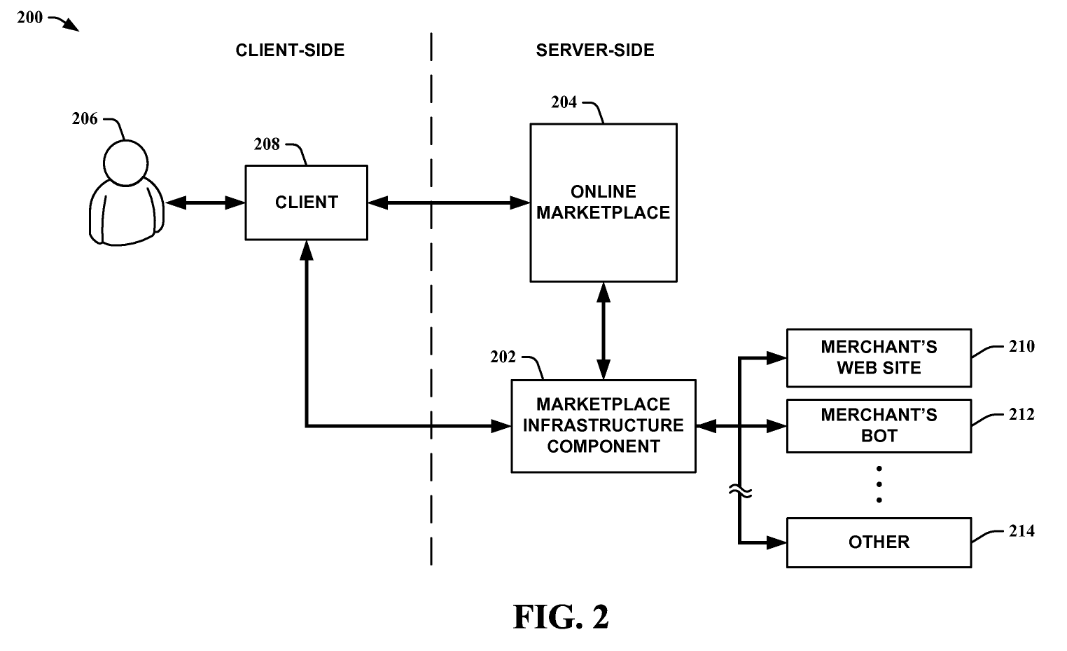

FIG. 2 illustrates a marketplace infrastructure system 200 that utilizes a marketplace infrastructure component 202 to provide marketplace infrastructures to an online marketplace 204. A user 206 interacts with the online marketplace 204 via a client 208. The marketplace infrastructure component 202 can provide infrastructures itself and/or utilize external infrastructures provided by external sources. These external sources can include, for example, a merchant's web site 210, a merchant's Bot 212, and/or other 214 which represents an infinite number of possible other external sources and the like. The external sources can also include the client 208.

For example, a merchant can have a web site that provides for bidding on items and transaction processing. The marketplace infrastructure component 202 can obtain these infrastructures and provide them to the online marketplace 204. This allows the user 206 to bid on items and pay for them without leaving the online marketplace 204. The marketplace infrastructure component 202 can also complement the external infrastructures with additional infrastructures, for example, such as merchant communications. This enables the user 206 to talk with the merchant before and/or after bidding and the like while in the online marketplace 204. Thus, the marketplace infrastructure system 200 substantially enhances the online marketplace 204 by providing added utility and decreased effort on the part of the user 206 in purchase-associated activities.

In other instances, the marketplace infrastructure component 202 can reside on a host device such as a server and the like and/or on the client 208. This flexibility allows the marketplace infrastructure component 202 to provide additional infrastructures to the online marketplace 204 that would not otherwise be practicable. For example, the user 206 can store personal information on the client 208 that is not available to an infrastructure on a host device such as a server. A drag and drop payment infrastructure residing on the client 208, however, allows the user 206 to easily pay for products/services shown in the online marketplace 204 without requiring the user 206 to input the information. Thus, the user 206, with a simple drag and drop motion, can provide payment information such as name, number, address, credit card information and the like with less than a click and without leaving the online marketplace 204. It can be appreciated that other infrastructures can be provided to the online marketplace 204 from the client 208 as well.

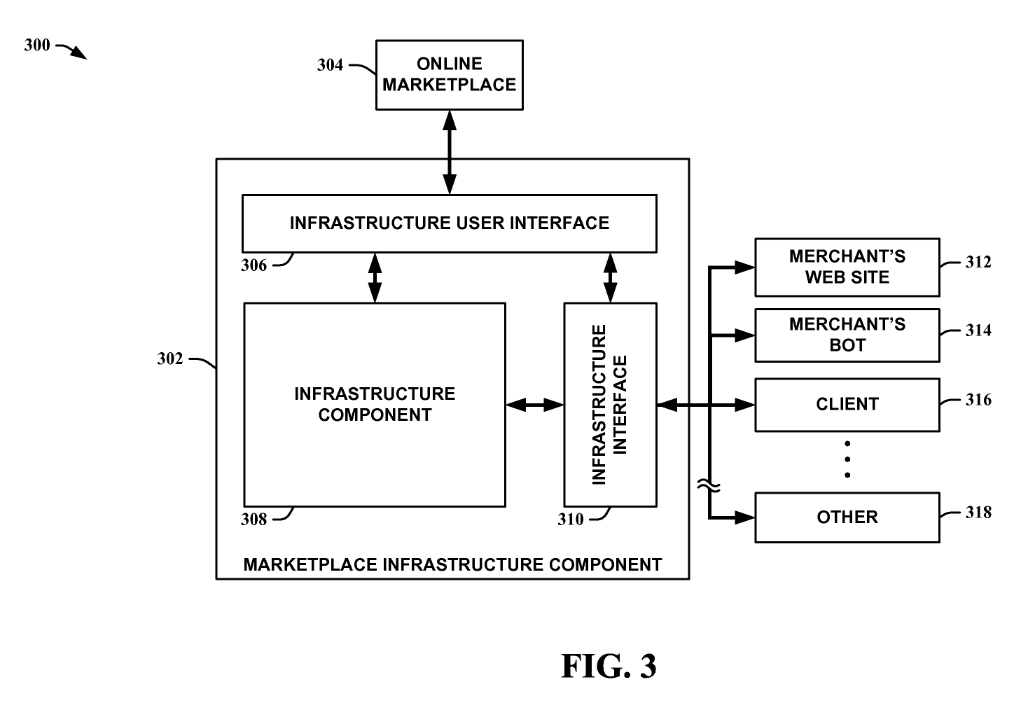

FIG. 3 illustrates a marketplace infrastructure system 300 that employs a marketplace infrastructure component 302 to interact with an online marketplace 304. The marketplace infrastructure component 302 utilizes an infrastructure component 308 to generate infrastructures that are then supplied to the online marketplace 304 via an infrastructure user interface 306. The infrastructure component 308 can create new infrastructures and/or obtain external existing infrastructures from external sources via the infrastructure interface 3 10. The external sources can include, for example, a merchant's web site 312, a merchant's Bot 314, a client 316, and/or other 318 which represents an infinite number of possible external sources and the like. Because the marketplace infrastructure component 302 can reside client-side and/or server side, it can include multiple interfaces and/or infrastructure components as well.

The infrastructure interface 3 10 can utilize a standardized interface to allow external devices to easily interact with the marketplace infrastructure component 302. The infrastructure interface 310 can also be active and utilize Bots and/or other mechanisms to extract infrastructures from external sources and the like. The external infrastructure information can be passed to the infrastructure component 308 and/or passed directly to the infrastructure user interface 306. The infrastructure component 308 can generate infrastructures, utilize external infrastructures, and/or combine generated and external infrastructures to form hybrid infrastructures. These infrastructures are then passed to the infrastructure user interface 306. The infrastructure user interface 306 provides the infrastructures to the online marketplace in a desired fashion. Thus, the infrastructure user interface 306 manipulates the infrastructure presentation to suit the online marketplace 304. This can include providing pop-up windows, nested windows, and/or other presentation mechanisms whether graphical and/or textual-based and the like. The infrastructure user interface 306 can also utilize external infrastructures directly from the infrastructure interface 310 if desired. The infrastructure user interface 310 interacts with the online marketplace 304 to support infrastructures utilized in the online marketplace 304. This can include, but is not limited to, calling additional infrastructures as needed and/or requesting generation of infrastructures by the infrastructure component 308 and/or requesting external infrastructures and the like.

The above systems substantially enhance marketplaces. Marketplaces are very important to consumers because they provide relevant information for executing a sale such as pricing information and ratings/reviews/comparisons for informed purchasing decisions. They help build consumer trust by collecting merchant feedback and by setting minimum merchant standards. Marketplaces attract customers by advertising themselves and/or by running loyalty programs and the like. Current marketplaces today cannot provide infrastructures as described above. However, with instances disclosed herein, consumers are now provided with infrastructure for such things, for example, as payment services, pricing mechanisms such as auctions and/or communications with merchants and the like. The marketplace infrastructure user interface can remain unobtrusive to a user and/or the marketplace until a user indicates intent. Once the user shows interest additional functionality appears such as, for example, obtaining additional information, merchant feedback ratings, one click or less purchasing, and/or merchant communications via VoIP and/or Instant Messaging, etc.

In one instance, if the user moves a pointer towards the box, i.e., an indication that the user is interested in the box, the box remains there. If the user moves the pointer away from the box, i.e., an indication that the user is not interested in the box, the box disappears. Other similar mechanisms can be employed to detect user intention as well. Standardized icons can also be employed to indicate functionality in advertisements which provide additional infrastructure. Such as, for example, a quick drag-and-drop buying experience, batch purchase across several merchants, integration of Instant Messaging and/or voice-over-IP to discuss directly with a merchant and/or its Bot and/or integration of a negotiation platform such as an auction and the like.

Icons can be utilized to indicate infrastructure functionality such as, for example: a more information icon—where hovering pops up a box with more-information, a VOIP icon—indicating Voice over IP functionality, an IM icon—for Instant Messaging with a person, a Bot IM icon—for Instant Messaging with a Bot, an email icon—for sending email to a merchant, a forward icon—for forwarding an advertisement to a person with/without remarks, a clip icon—for clipping advertisements and/or information for later reference, a calendar icon—for adding product/service information to a calendar, a batch cart icon—for adding items to a “batched” purchase cart, a drag-n-drop icon—for indicating drag-and-drop to purchasing, and/or a negotiation icon—for indicating price negotiation availability and the like. It can be appreciated that these are just a few of the infinite number and types of icons that can be utilized with instances disclosed herein. These icon examples represent functionalities and/or applications supported by the supplied infrastructure. These icons enable these functionalities right from an advertisement in a marketplace. A user is not required to visit the merchant web site to avail these functionalities and, thus, can remain in the marketplace, possibly making additional purchases.

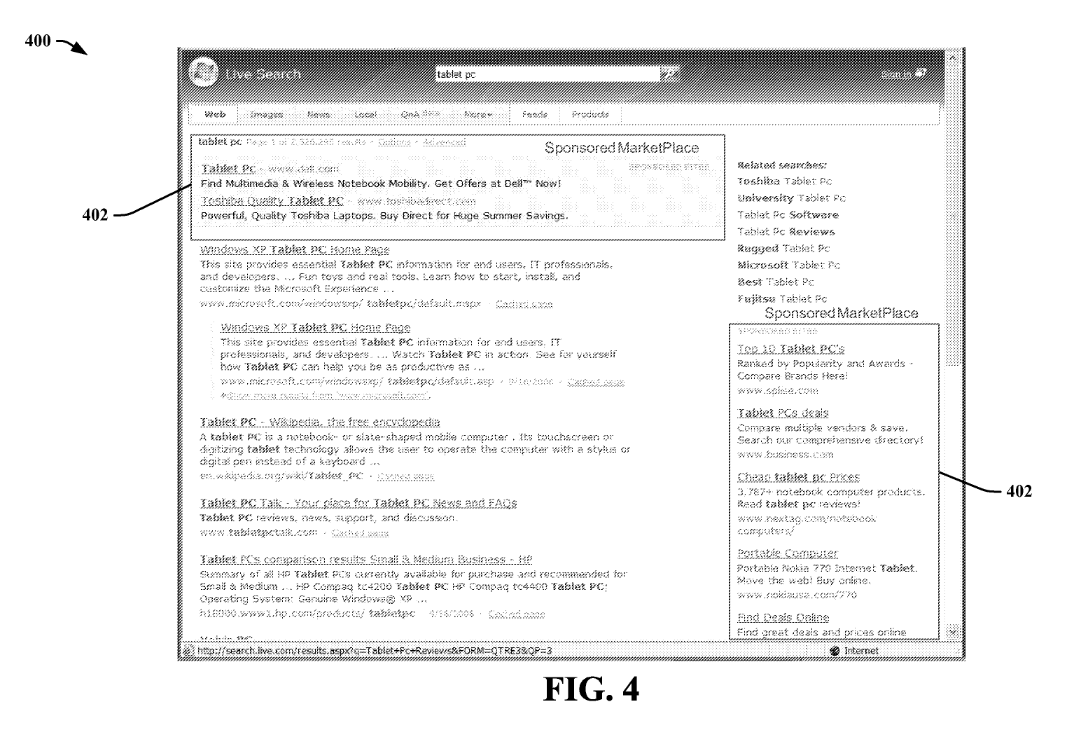

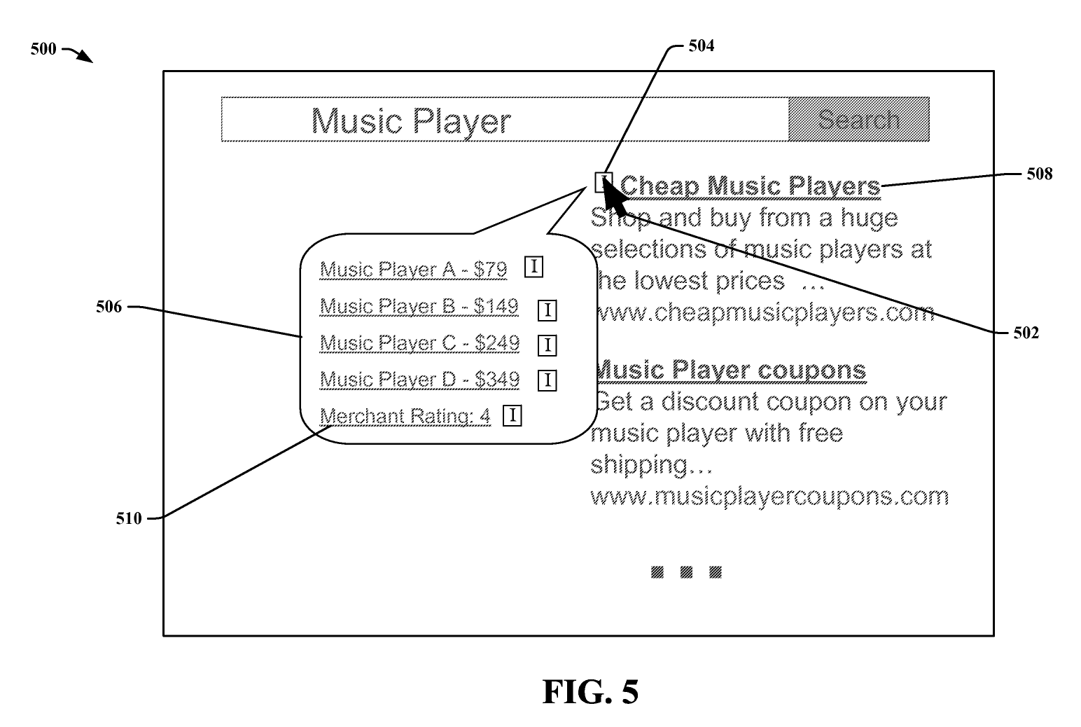

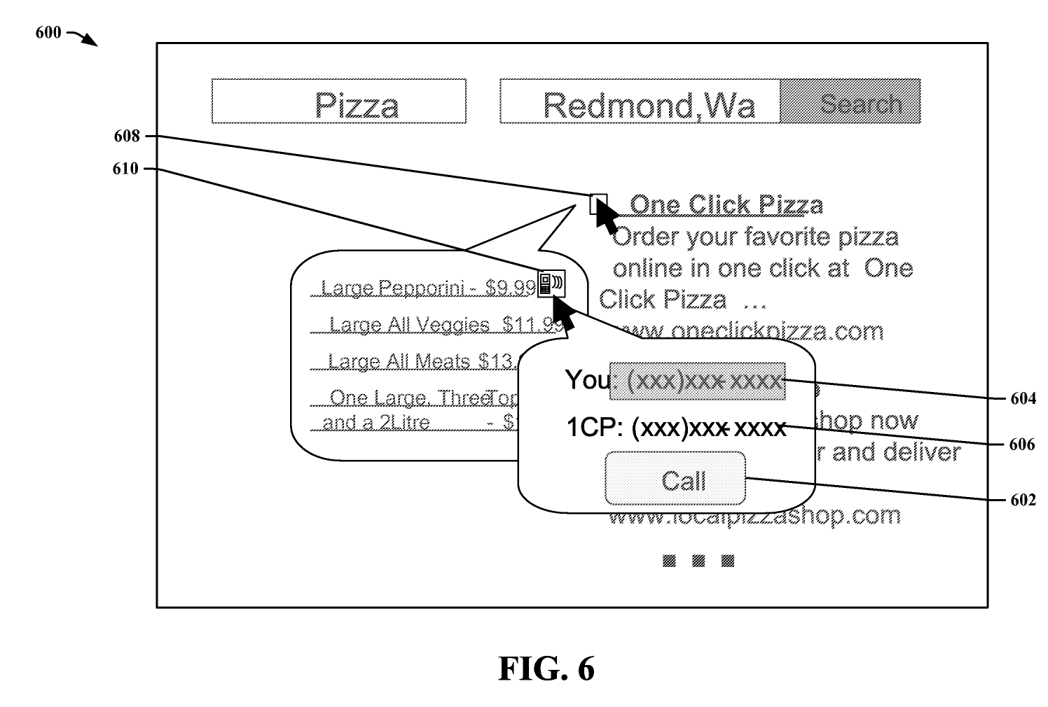

FIG. 4 is illustrates of an example online marketplace 400 with sponsored marketplace areas 402 where merchants can advertise. This example online marketplace 400 utilizes a search engine web page. FIG. 5 shows an example 500 where hovering a pointer 502 on an icon 504 gives more information 506 supplied by marketplace infrastructure. Clicking a link 508 can still take a user to a product web site. Communication infrastructures exampled infra can also be utilized to gather feedback for merchants and/or marketplaces and the like. For example, a “merchant rating” indictor 510 shows an accumulation of feedback for a particular merchant that is displayed in more information 506. FIG. 6 depicts an example voice-over-IP merchant communication infrastructure 600. A user has selected an initial icon 608 and then a secondary icon 610 to initialize merchant communication functions. Pressing a Call button 602 initiates communications between a merchant and a user. The user's phone number 604 can be picked from a browser cookie, passport account, and/or a toolbar and the like. The user can still have the ability to change the number if so desired. Merchant's number 606 is supplied by the merchant associated with the advertisement. If the user has unified communications installed on their computer then even that can be used instead of VoIP.

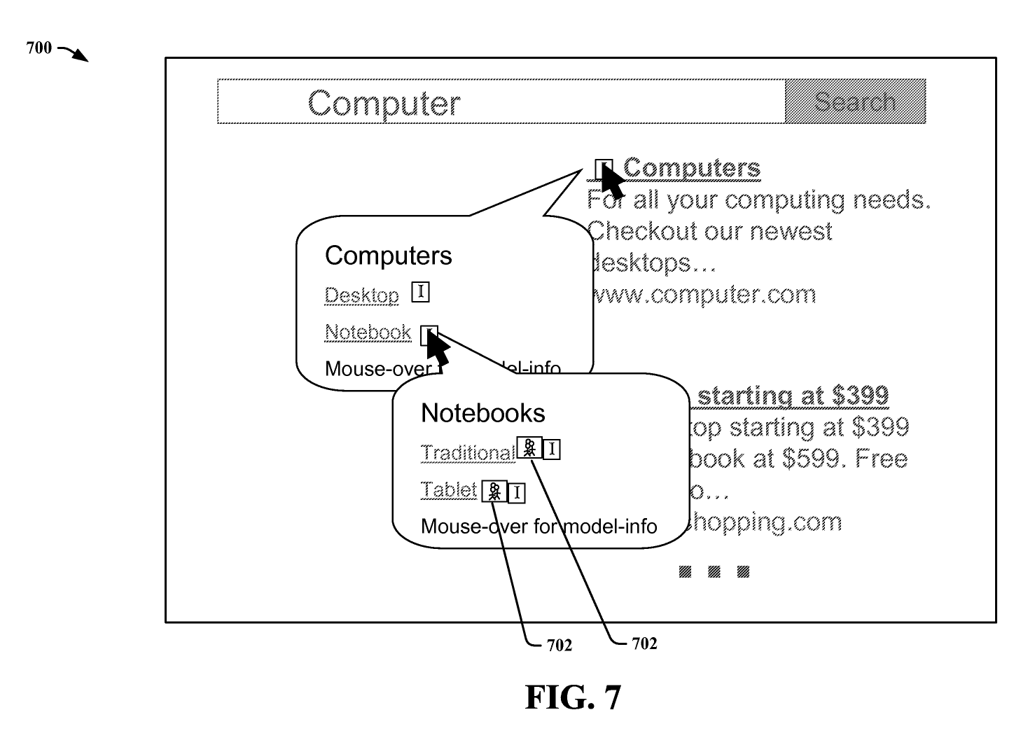

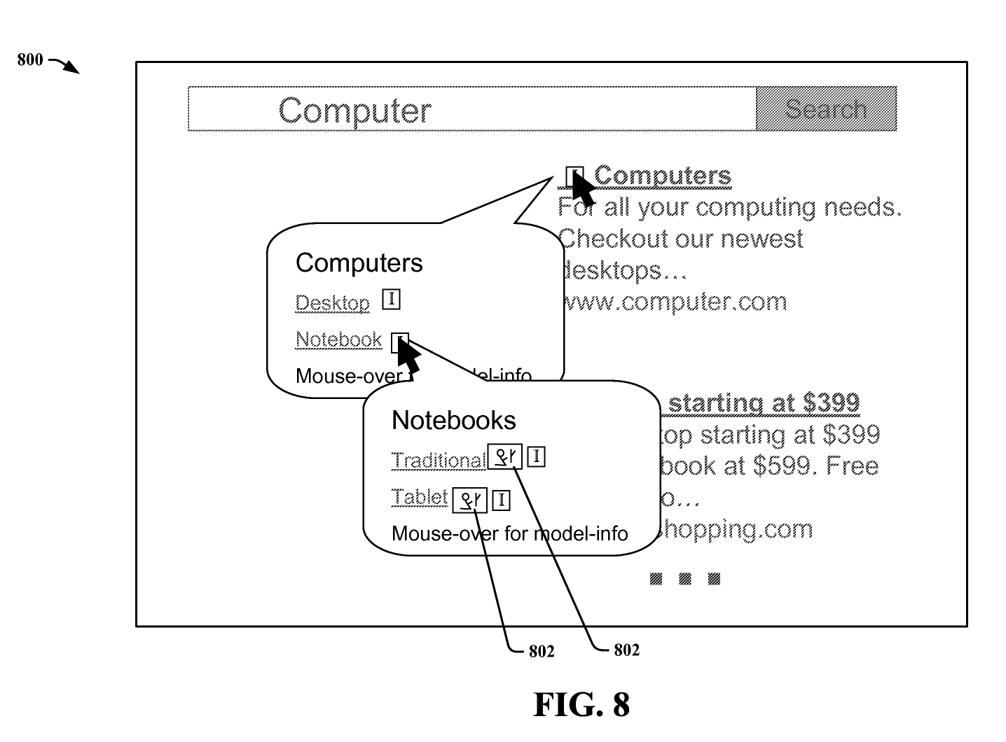

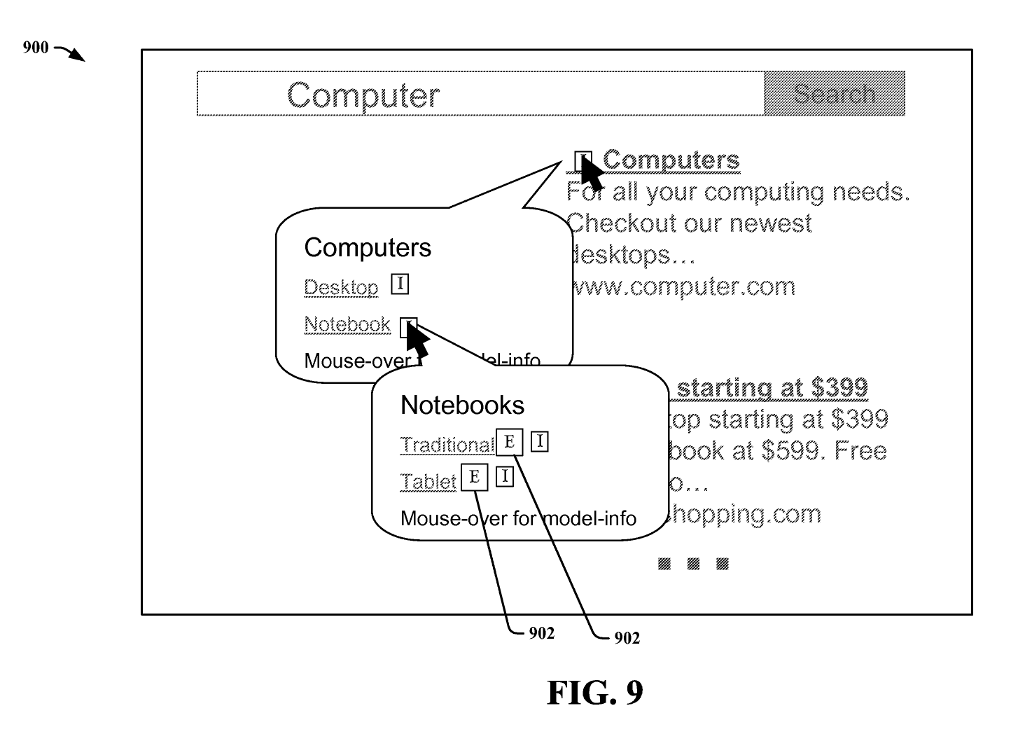

FIG. 7 is illustrates an example instant messaging (IM) merchant communication infrastructure 700. Clicking an IM icon 702 starts a chat session between a merchant and a user. The chat session can either launch a separate Instant Messaging application with a merchant's address already filled in and an initial message sent with a product name in which the user is interested in, or it can even launch a chat session within the browser window itself FIG. 8 depicts an example Instant Messaging (IM) merchant Bot communication infrastructure 800. Clicking a Bot-messaging icon 802 starts a chat session between a merchant's Bot and a user. This has the same functionality as on the IM icon 702 in FIG. 7 except the merchant employs a Bot to interact with the user. FIG. 9 shows an example email merchant communication infrastructure 900. Clicking an email icon 902 either opens a new email or a text box where a user can write a quick message to a merchant depending upon the user's preference. The new email can be pre-filled with a product's description as a subject line. The user can either give feedback to the merchant and/or ask questions about the product using this email functionality.

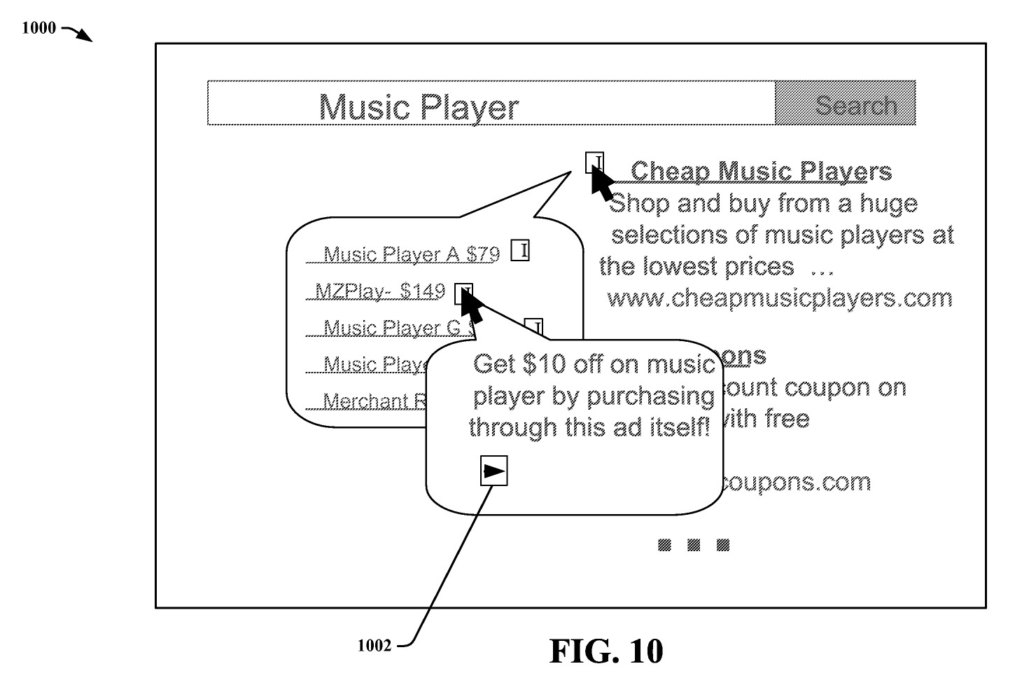

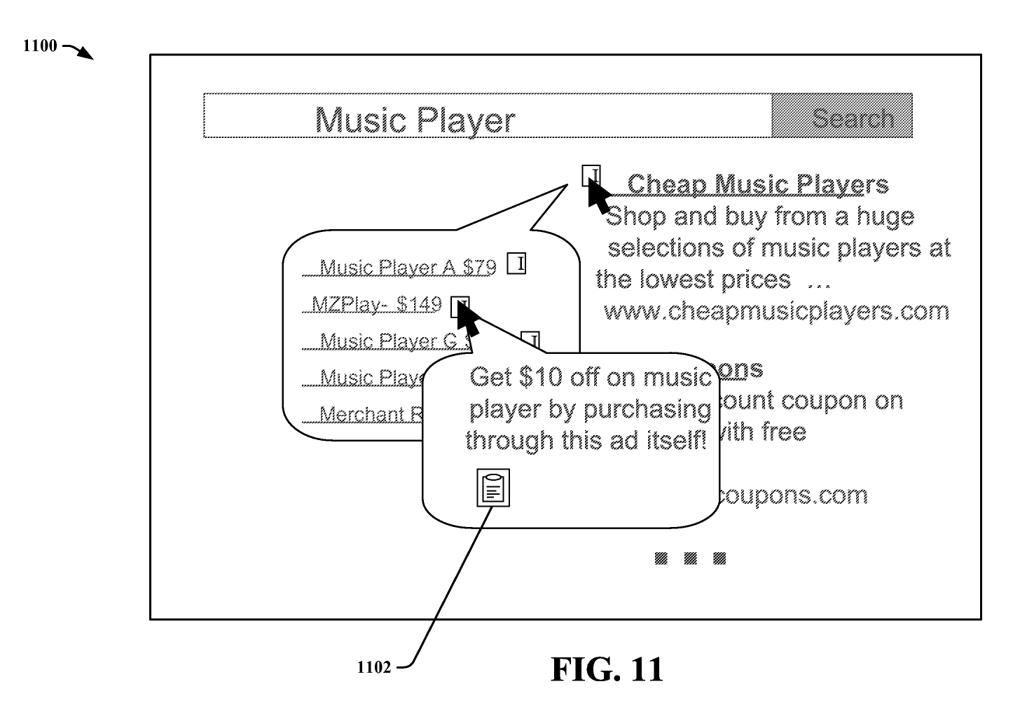

FIG. 10 illustrates an example advertisement forwarding infrastructure 1000. A forwarding icon 1002 can be employed to forward an advertisement to a friend who, for example, may appreciate a $10 discount. This can be easily accomplished with this infrastructure. The friend could then get the discount if it is applicable at the time of purchase too. A user can forward the advertisement to themselves as well. Other icons can be utilized to enable the functionality to buy through the advertisement itself as described infra. FIG. 11 depicts an example advertisement clipping infrastructure 1100. A clipping icon 1102 can be employed to clip an advertisement for later use, for example, to get a $10 discount. One would then get the discount if it is applicable at the time of purchase. The clip infrastructure can store the advertisement through a browser cookie and/or on a toolbar on a client-side and/or in a passport account on a server-side. Even without a discount as motivation, this functionality is useful for other purposes such as, for example, product research and the like.

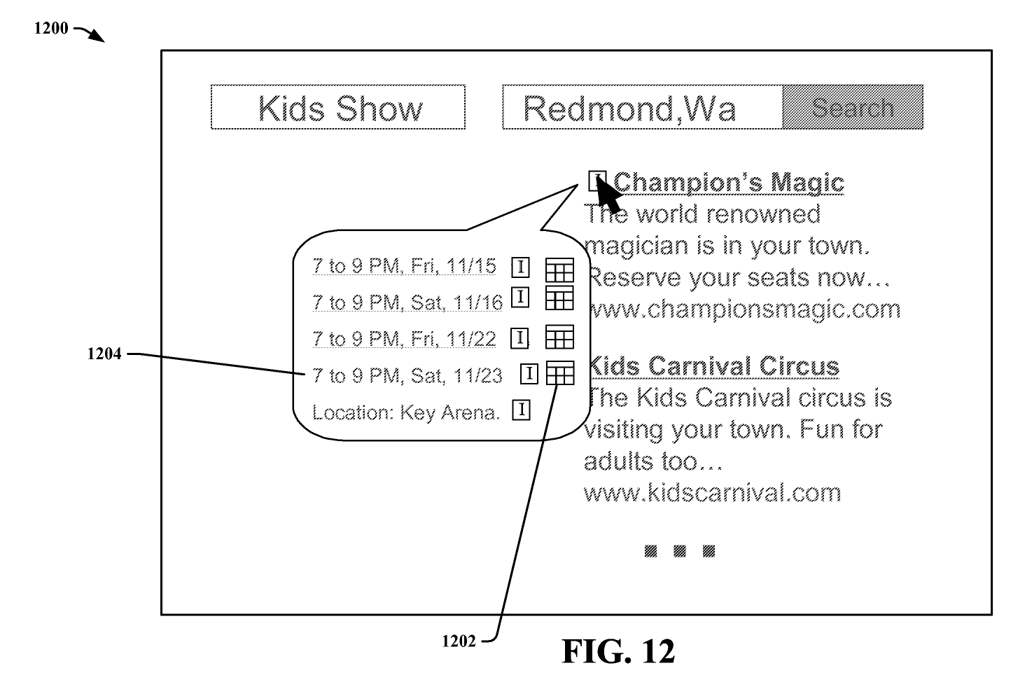

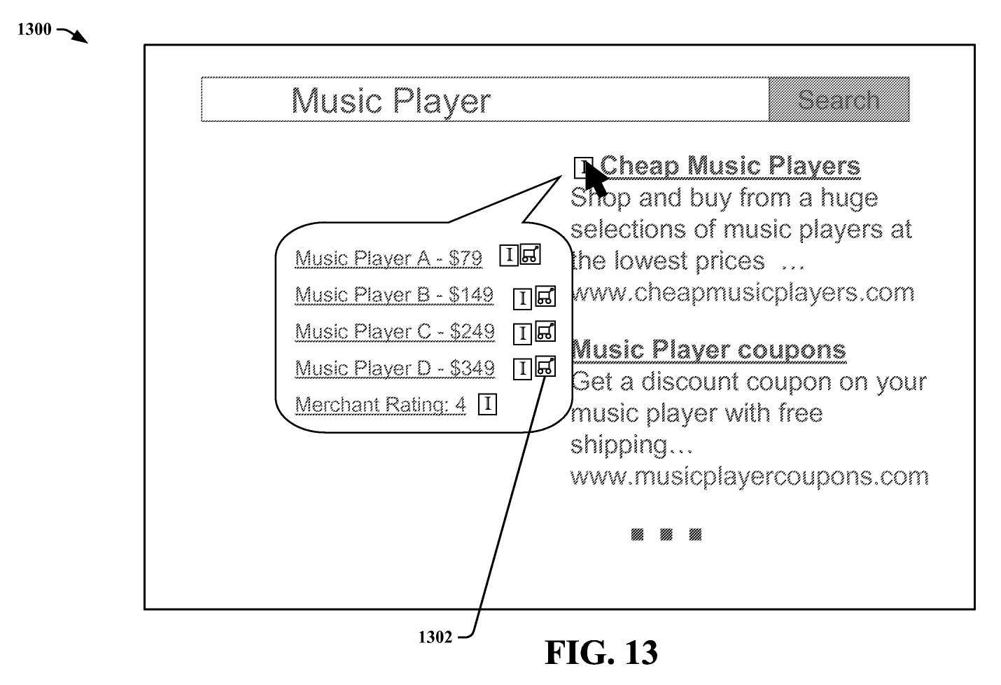

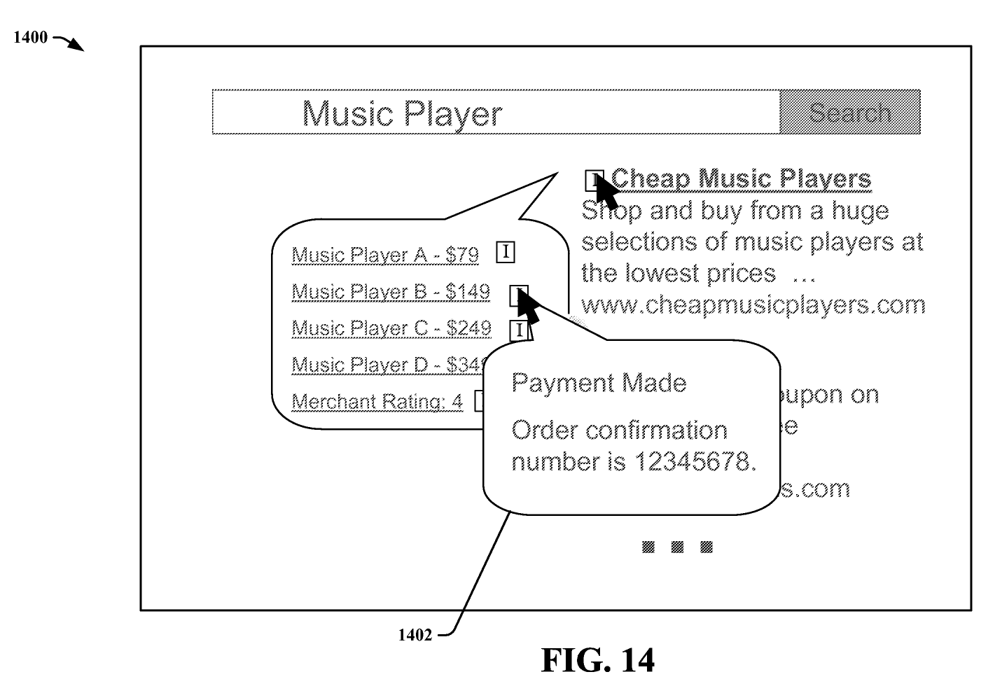

FIG. 12 shows an example calendar entry infrastructure 1200. Clicking a calendar icon 1202 adds, for example, a show 1204 to a calendar. One can use existing technology such as iCal and Live Clipboard as the basis for the infrastructure. FIG. 13 depicts an example batch purchasing infrastructure 1300. Clicking a cart icon 1302 stores the item in a batched cart. Items in the batched cart can be purchased as a single purchase, even if the items are from different merchants. Items in the batched cart, for example, can also be published as a gift registry and/or on a blog with personal comments and the like. FIG. 14 illustrates an example drag and drop purchasing infrastructure 1400. Dragging-the-mouse enables a purchase of products/services right from the marketplace itself. A dragged card 1402 typically has both shipping and billing information. One can use other methods such as, for example, a toolbar and/or filling forms in manually. If the merchant is giving an attractive credit offer, a card can also have a credit application attached to it.

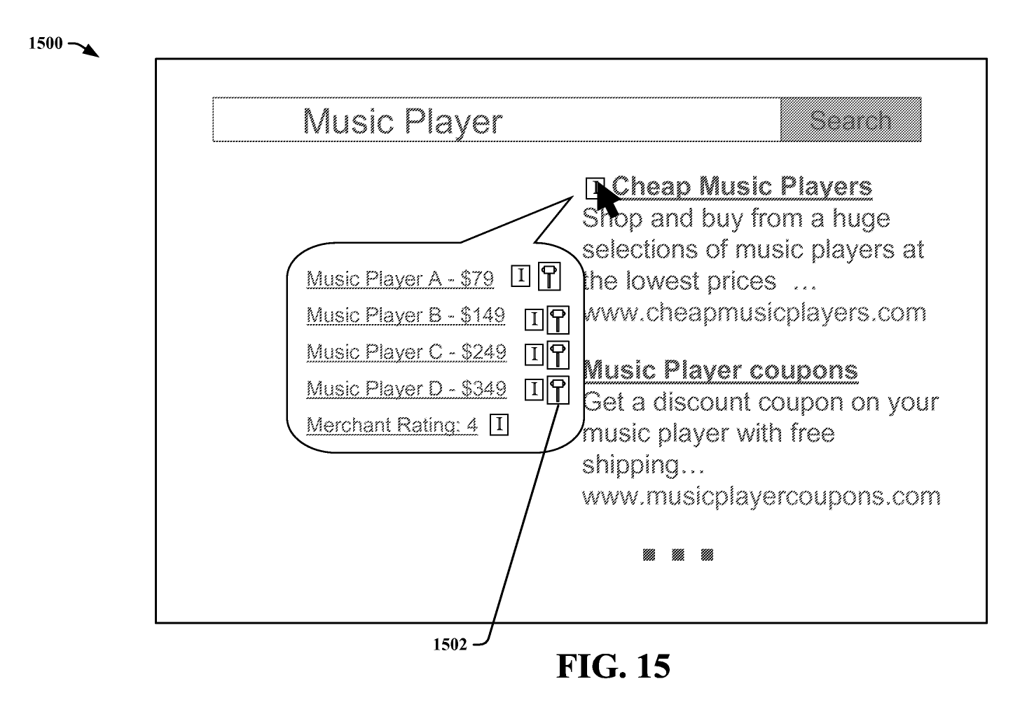

FIG. 15 shows an example auction and/or negotiation infrastructure 1500. A negotiation icon 1502 enables, for example, price negotiation and/or quantity negotiation and the like. If, for example, a user wants to pay a different price than what a merchant is asking, the user can employ this feature. A user can submit a payment method of what they would like to offer. The user can submit a payment to multiple merchants. For example, the first merchant to accept can charge the user and the offer is withdrawn from other merchants. Disposable credit cards and/or temporary negotiation mechanisms can be employed as well.

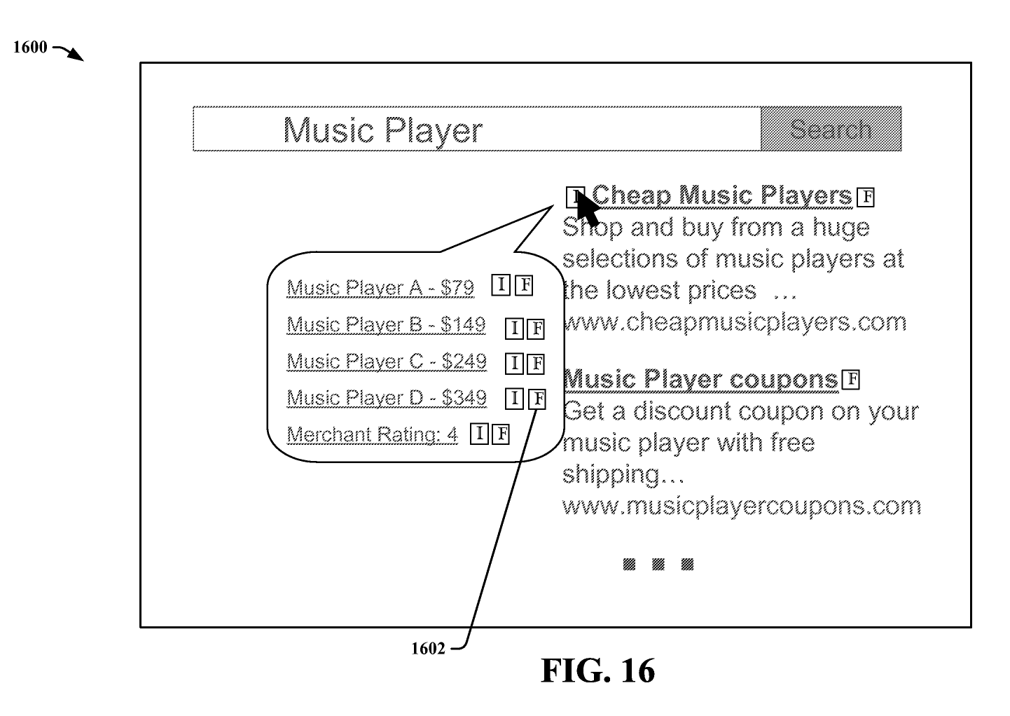

FIG. 16 illustrates an example feedback infrastructure 1600. A feedback icon 1602 allows a user to leave feedback for merchants, items, and/or advertisements and the like. For an example, a user can communicate via the feedback infrastructure about a shopping experience and/or even an advertisement experience (e.g., a user can communicate that an advertisement is misplaced and should not be shown on this page, is inappropriate, etc.). Because of the ease in which feedback can be left, users are more likely to indicate their true level of satisfaction at the time the feedback is left (e.g., rather than going through a complicated process that occurs at a significantly later time, etc.).

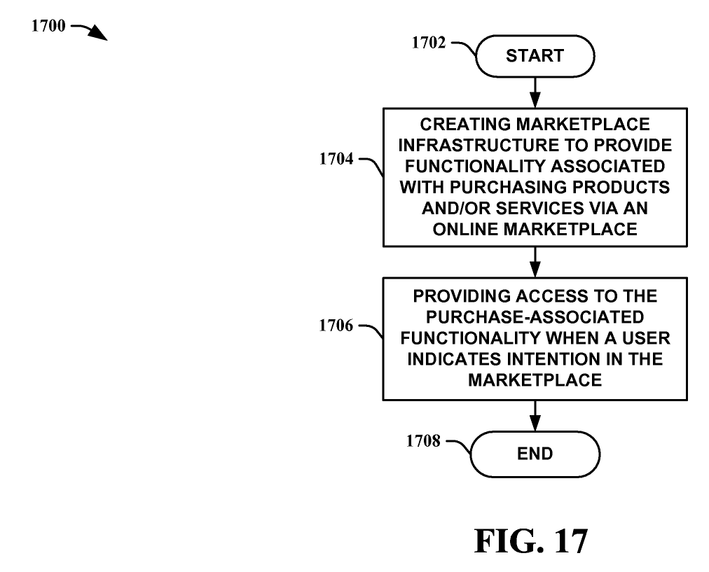

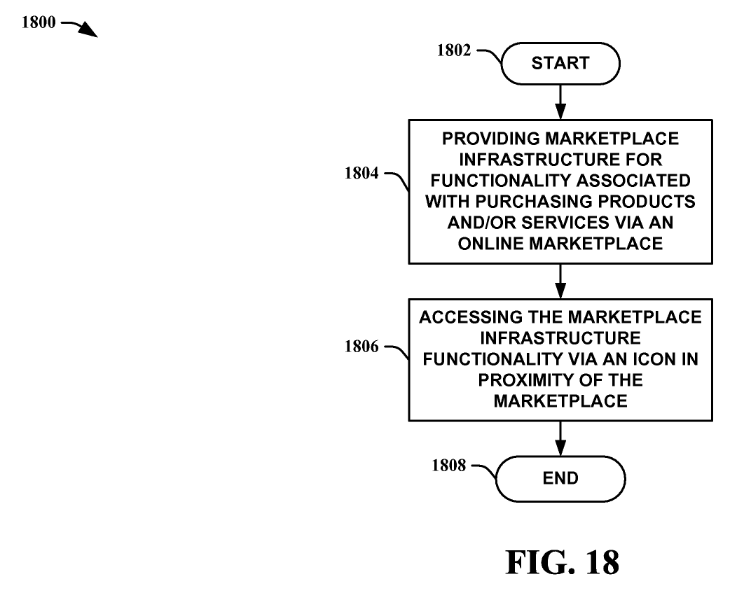

In view of the exemplary systems shown and described above, methodologies that may be implemented in accordance with the embodiments will be better appreciated with reference to the flow charts of FIGS. 17 and 18. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 17, a flow diagram of a method 1700 for providing online marketplace infrastructure in accordance with an aspect of an embodiment is shown. The method 1700 starts 1702 by creating marketplace infrastructure to provide functionality associated with purchasing products and/or services via an online marketplace 1704. The marketplace infrastructure can be created utilizing generated infrastructures, utilizing externally obtained infrastructures, and/or hybrid infrastructures based on external and generated infrastructures and the like. The marketplace infrastructure supports purchase-associated functionality from within the online marketplace. The purchase-associated functionality can include, but is not limited to, payment services, pricing mechanisms, comparison shopping, and/or merchant communications and the like.

Thus, a user can purchase products/services directly from a merchant, communicate directly and/or indirectly (e.g., via Bots) with a merchant, and/or make batch purchases across multiple merchants and the like. The marketplace infrastructure can be created and/or supported on a host device and/or on a client device and the like. Access to the purchase-associated functionality is provided when a user indicates intention in the marketplace 1706, ending the flow 1708. Intention can be determined by many different mechanisms including, but not limited to, user interactions with a pointing device such as hovering and/or clicking, eye movements that indicate intention, verbal commands that indicate intention, and/or other environmental-based mechanisms and the like.

Turning to FIG. 18, a flow diagram of a method 1800 for selecting online marketplace infrastructure in accordance with an aspect of an embodiment is depicted. The method 1800 starts 1802 by providing marketplace infrastructure for functionality associated with purchasing products and/or services via an online marketplace 1804. The infrastructure can be provided by mechanisms described supra. The marketplace infrastructure functionality is then accessed via an icon in proximity of the marketplace 1806, ending the flow 1808. Different icons can be utilized to indicate different functionality supported by an infrastructure. For example, an icon near a merchant's advertisement can indicate that it is supported by additional infrastructure. A user can show interest in the icon, for example, by clicking on and/or hovering over the icon until a pop-up window appears with additional icons that support additional infrastructure functionality. Subsequent pop-up windows can appear as subsequent icons are selected. There is no limit to the number and/or type of functions/functionality supported by implemented infrastructures.

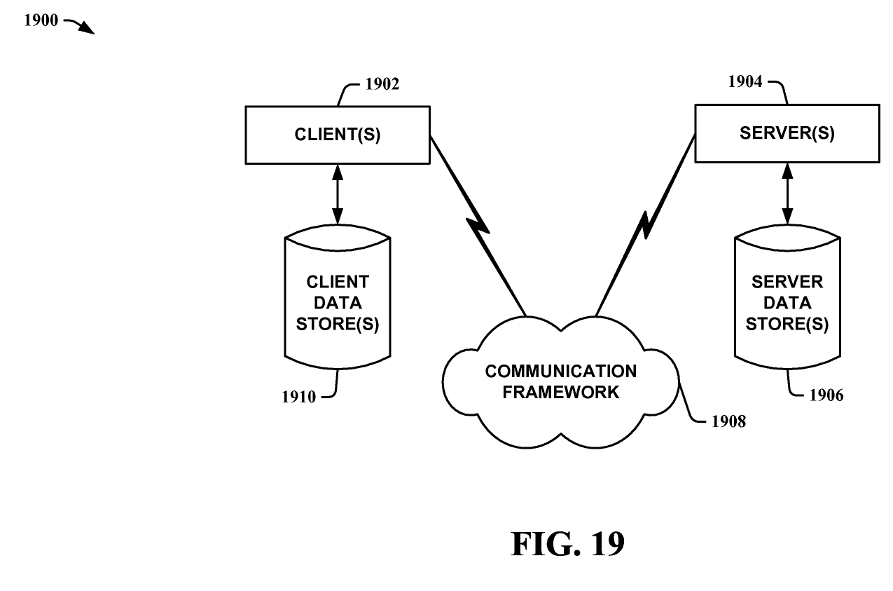

FIG. 19 is a block diagram of a sample computing environment 1900 with which embodiments can interact. The system 1900 further illustrates a system that includes one or more client(s) 1902. The client(s) 1902 can be hardware and/or software (e.g., threads, processes, computing devices). The system 1900 also includes one or more server(s) 1904. The server(s) 1904 can also be hardware and/or software (e.g., threads, processes, computing devices). One possible communication between a client 1902 and a server 1904 can be in the form of a data packet adapted to be transmitted between two or more computer processes. The system 1900 includes a communication framework 1908 that can be employed to facilitate communications between the client(s) 1902 and the server(s) 1904. The client(s) 1902 are connected to one or more client data store(s) 1910 that can be employed to store information local to the client(s) 1902. Similarly, the server(s) 1904 are connected to one or more server data store(s) 1906 that can be employed to store information local to the server(s) 1904.

It is to be appreciated that the systems and/or methods of the embodiments can be utilized in online marketplace enhancement facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that enhances an online marketplace, comprising:
a marketplace infrastructure component that creates interactive marketplace infrastructures; and
an infrastructure user interface that provides the interactive marketplace infrastructures for utilization with an online marketplace.

2. The system of claim 1 further comprising:
a marketplace infrastructure interface that interacts with external sources to provide external infrastructures to the marketplace infrastructure component.

3. The system of claim 2, the marketplace infrastructure interface interacts with a client to provide an infrastructure to the marketplace infrastructure component.

4. The system of claim 2, the marketplace infrastructure interface interacts with an online marketplace advertiser's web site and/or Bot to provide an infrastructure to the marketplace infrastructure component.

5. The system of claim 1, the infrastructure user interface provides the interactive marketplace infrastructures based, at least in part, on a user's intent towards an advertisement in the online marketplace.

6. The system of claim 1, the marketplace infrastructure component resides on a client and/or server computing system.

7. The system of claim 1, the marketplace infrastructure component creates infrastructures for product queries, advertiser communications, advertisement forwarding, advertisement clipping, calendar entries, batch purchasing, drag-and-drop purchasing, auctions, and/or negotiations.

8. A method for enhancing an online marketplace, comprising:
creating marketplace infrastructure to provide functionality associated with purchasing products and/or services via an online marketplace; and
providing access to the purchase-associated functionality when a user indicates intention in the marketplace.

9. The method of claim 8 further comprising:
creating marketplace infrastructure on a client to provide functionality associated with purchasing products and/or services.

10. The method of claim 8, the purchase-associated functionality comprising payment services, pricing mechanisms, comparison shopping, and/or merchant communication mechanisms.

11. The method of claim 8 further comprising:
purchasing a product and/or service directly from a merchant via the marketplace infrastructure.

12. The method of claim 8 further comprising:
providing marketplace infrastructure that allows batch purchasing of products from different merchants.

13. The method of claim 8 further comprising:
establishing communications directly with a merchant via the marketplace infrastructure.

14. The method of claim 8 further comprising:
accessing the purchase-associated functionality via an icon placed in proximity of the marketplace.

15. The method of claim 8 further comprising:
employing online marketplace host and client jointly to provide the marketplace infrastructure.

16. A system that enhances an online marketplace, comprising:
means for generating interactive marketplace structures; and
means for providing the interactive marketplace structures to an online marketplace.

17. The system of claim 16 further comprising:
means for interacting with a client computing system and/or a merchant to build the interactive marketplace structures.

18. A computer readable medium having stored thereon computer executable components of the system of claim 1.

19. A device employing the method of claim 8 comprising a computer, a server, and/or a handheld electronic device.

20. A device employing the system of claim 1 comprising a computer, a server, and/or a handheld electronic device.
